(19) United States
(12) Patent Application Publication
(10) Pub. No.: US 2006/0018516 A1
(43) Pub. Date: Jan. 26, 2006

(54) Monitoring activity using video information

(76) Inventors: Osama T. Masoud, Minneapolis, MN (US); Nikolaos Papanikolopoulos, Minneapolis, MN (US); Nathaniel D. Bird, Minneapolis, MN (US)

Correspondence Address: Schwegman, Lundberg, Woessner & Kluth, P.A., P.O. Box 2938, Minneapolis, MN, 55402, US

(21) Appl. No.: 11/188,288

(22) Filed: Jul. 22, 2005

Related U.S. Application Data
(60) Provisional application No. 60/590,242, filed on Jul. 22, 2004.

(51) Int. Cl. G06K 9/00

(52) U.S. Cl. 382/115

(57) ABSTRACT

Apparatus and methods for monitoring activity use video information to track activity of a target at a given location. In an embodiment, the target is segmented into portions and a value of a biometric attribute is associated with the target and compared against values of a biometric attributes of corresponding portions of other images to identify the target and determine a length of time that the target is at the given location.

### RELATED APPLICATION

This application claims priority under 35 U.S.C. 119(e) from U.S. Provisional Application Ser. No. 60/590,242 filed 22 Jul. 2005, which application is incorporated herein by reference.

### GOVERNMENT INTEREST STATEMENT

Features described herein have been partially supported by the Minnesota Department of Transportation and the National Science Foundation through grants #CMS-0127893 and #IIS-0219863. The Government may have certain rights in the invention.

### TECHNICAL FIELD OF THE INVENTION

The present invention relates generally to techniques and apparatus for monitoring activity, for example, activity of humans.

### BACKGROUND OF THE INVENTION

Recognition of human actions from video streams has many applications in the surveillance, entertainment, user interfaces, sports and video annotation domains. Given a number of predefined actions, the problem can be stated as that of classifying a new action into one of these actions. Normally, the set of actions has a meaning in a certain domain. In sign language for example, the set of actions corresponds to the set of possible words and letters that can be produced. In ballet, the actions are the step names in one of the ballet notation languages.

In psychophysics, the study of human body motion perception by the human visual system was made possible by the use of the so-called moving light displays (MLDs) first introduced in 1973. A method was devised to isolate the motion cue by constructing an image sequence where the only visible features are a set of moving lights corresponding to joints of the human body. FIG. 1 shows an example. It was found that when a subject was presented an MLD corresponding to an actor performing an activity such as walking, running, or stair climbing, the subject had no problem recognizing the activity in under 200 milliseconds. The subjects were not able to identify humans when the lights were stationary. It has been demonstrated that the gender of the walking person and the gait of a friend can be identified from MLDs. It also has been shown that subjects can identify more complex movements such as hammering, box lifting, ball bouncing, dancing, greeting, and boxing. Two theories on how people recognize actions from MLDs have been suggested. In the first theory, the visual system performs shape-from-motion reconstruction of the object and then uses that to recognize the action. In the second theory, the visual system utilizes motion information directly without performing reconstruction.

Research has been conducted in the field of segmentation. Prior methods for motion segmentation such as static background subtraction work fairly well in constrained environments. But these methods are not suitable for unconstrained, continuously changing environments like outdoor scenes. So, it is important to find a statistical way to model the color of each pixel that can work even with unconstrained scenes. One of the simplest methods is to model the intensity of each pixel by a single Gaussian. This works well in relatively static indoor environments. Alternatively, a mixture of three Gaussians for each pixel using an incremental maximization method has been used. A mixture of Gaussians for each pixel has been used to adaptively learn the model of the background. In another method, nonparametric kernel density estimation has been used for scene segmentation in complex outdoor scenes.

There has also been a plethora of research into the area of vision-based tracking. For example, multi-level tracking has been used for monitoring traffic. Three-level tracking consisting of regions, people, and groups in indoor and outdoor environments has been performed. Kalman filter-based feature tracking for predicting trajectories of humans has been implemented. A tracker based on two linear Kalman filters, one for estimating the position and the other for estimating the shape of the vehicles in a highway scene, has been used. Some other tracking methods are based on the color distribution of the target and not on position prediction through a Kalman filter. This is the case for a method developed in which the new target position is found by searching in the target's neighborhood in the current frame and computing a correlation score, the Bhattacharyya coefficient.

The problem of identifying humans from video in controlled environments is quite challenging. The problem becomes further exacerbated when the video is of an outdoor scene and when humans are distant from the camera, occupying a small area within the image. Not much research has dealt with all these complexities in the past. Previous research into visual recognition deals with recognizing objects and actions in very constrained, structured environments. An approach introduces a system that first creates a library of images for each object to be recognized by taking pictures of it from many different angles. The model formed from this library of images is then shown to be able to recognize the object from any novel angle. This is performed in a controlled, indoor environment on rigid objects. Another approach utilized a color-density based image segmentation method to aid in the location of people within a video segment by locating color “blobs” relating to the head, torso, and legs of a person. To identify specific actions, another approach introduced a system that compares the optical flow pattern in a novel video of a person performing an unknown action to a database of optical flow patterns for known actions. A matching algorithm is used to determine whether both videos show people performing the same action. This is shown to work decently in specific outdoor environments devoid of shadows and significant forms of occlusion. This method is also limited by the scope of its action database but seems promising for identifying well defined behaviors.

### LITERATURE

[1] Akita, K., “Image sequence analysis of real world human motion,” Pattern Recognition, 17(1) (1984) 73-83.
[2] Azarbayejani, A., and Pentland, A., “Real-time self-calibrating stereo person tracking using 3-D shape estimation from blob features,” in Proc. of International Conference on Pattern Recognition, Vienna (1996).
[3] Belhumeur, P., Hespanha, J., and Kriegman, D., “Eigenfaces vs. fisherfaces: Recognition using class specific linear projection,” IEEE Transactions on Pattern Recognition and Machine Intelligence, 19(7) (1997)711-720.
[4] BenAbdelKader, C., Cutler, R., and Davis, L. S., “Motion-based recognition of people in eigengait space,” 5th International Conference on Automatic Face and Gesture Recognition, 2002.
[5] Bobick, A., Davis, J., Intille, S., Baid, F., Campbell, L., lvanov, Y., Pinhanez, C., Schutte, A., and Wilson, A., “KIDSROOM: Action recognition in an interactive story environment,” MIT Media Lab Perceptual Computing Group Technical Report No. 398, MIT (December 1996).
[6] Bregler, C., “Learning and recognizing human dynamics in video sequences,” in Proc. of IEEE Conference on Computer Vision and Pattern Recognition (June 1997).
[7] Bregler, C. and Mallik, J., “Tracking people with twists and exponential maps,” in Proc. of IEEE Conference on Computer Vision and Pattern Recognition (June 1998) 8-15.
[8] Cai, Q. and Aggarwal, J. K., “Tracking human motion using multiple cameras,” in Proc. of the 13th International Conference on Pattern Recognition (1996) 68-72.
[9] Campbell, L. and Bobick, A., “Recognition of human body motion using phase space constraints,” in Proc. of International Conference on Computer Vision, Cambridge(1995) 624-630.
[10] Cedras, C. and Shah, M., “Motion-based recognition: a survey,” Image and Vision Computing, vol. 13, no. 2, pp. 129-155, March 1995.
[4] Comanciu, D., Ramesh, V., and Meer, P., “Kernel-based object tracking,” IEEE Transactions on Pattern Analysis and Machine Intelligence, vol. 25, no. 5, pp. 564-577, May 2003.
[6] Cucchiara, R., Mello, P., and Piccardi, M., “Image analysis and rule-based reasoning for a traffic monitoring system,” IEEE Transactions on Intelligent Transportation Systems, vol. 1, no. 2, pp. 119-130, June 2000.
[11] Cutting, J. E. and Kozlowski, L. T., “Recognizing friends by their walk: Gait perception without familiarity cues,” Bull. Psychonometric Soc., 9(5) (1977) 353-356.
[12] Davis, J. W. and Bobick, A. F., “The representation and recognition of human movement using temporal templates,” in Proc. of IEEE Computer Vision and Pattern Recognition (1997) 928-934.
[13] DiFranco, D. E., Cham, T. J., and Rehg, J. M., “Reconstruction of 3-D figure motion from 2-D correspondences,” in Proc. of IEEE Conference on Computer Vision and Pattern Recognition (June 2001) 307-314
[14] Dittrich, W. H., “Action categories and the perception of biological motion,” Perception 22 (1993) 15-22.
[11] Efros, A. A., Berg, A. C., Mori, G., and Malik, J., “Recognizing action at a distance,” Proceedings of IEEE International Conference on Computer Vision, pp. 726-733, October 2003.
[3] Elgammal, A., Duraiswami, R., Harwood D., and Davis, L. S., “Background and foreground modeling using nonparametric kernel density estimation for visual surveillance,” Proceedings of the IEEE, vol. 90, pp. 1151-1163, July 2002.
[15] Foster, J. P., Nixon, M. S., and Prugel-Bennet, A., New area based metrics for automatic gate recognition,” in Proc. BMVC (2001) 233-242.
[5] Friedman, N. and Russel, S., “Image segmentation in video sequences, a probabilistic approach” Proceedings of the Thirteenth Conference on Uncertainty in Artificial Intelligence, August 1997.
[16] Gavrila, D. M., “The visual analysis of human movement: a survey,” Computer Vision and Image Understanding, vol. 73, no. 1, pp. 82-98, January 1999.
[17] Gavrila, D. M. and Davis, L. S., “3-D model-based tracking of humans in action: a multi-view approach,” in Proc. of IEEE Conference on Computer Vision and Pattern Recognition, San Francisco (1996) 73-80.
[18] Goddard, N., “Incremental model-based discrimination of articulated movement direct from motion features,” in Proc. of IEEE Workshop on Motion of Non-Rigid. and Articulated Objects, Austin (1994) 89-94.
[19] Guo, Y., Xu, G. and Tsuji, S., “Understanding human motion patterns,” in Proc. of the 12th IAPR International Conference on Pattern Recognition (1994) 325-329.
[20] Halevi, G. and Weinshall, D., “Motion of disturbances: detection and tracking of multi-body non-rigid motion,” in Proc. of IEEE Conference Computer Vision and Pattern Recognition, Puerto Rico (June 1997) 897-902.
[21] Huang, P. S., Harris, C. J., and Nixon, M. S., “Human gait recognition in canonical space using temporal templates,” IEEE Proc. VISP 14(2) 1999 93-100.
[22] Johansson, G., “Visual perception of biological motion and a model for its analysis, Perception and Psychophysics” 14(2) (June 1973) 201-211.
[23] Johansson, G. “Visual motion perception,” Sci. Amer. 232 (June 1976) 75-88.
[24] Ju, S., Black, M., and Yacoob, Y., “Cardboard people: A parameterized model of articulated image motion,” in Proc. of IEEE International Conference on Automatic Face and Gesture Recognition, Killington (1996) 38-44.
[9] Koller, D., Weber J., and Malik, J., “Robust multiple car tracking with occlusion reasoning,” Proceedings of Third European Conference on Computer Vision, vol. 1, 1994.
[25] Kozlowski, L. T. and Cutting, J. E., “Recognizing the sex of a walker from dynamic point-light displays,” Perception and Psychophysics 21 (6) (1977) 575-580.
[26] Krahnstover, N., Yeasin, M., and Sharma, R., “Towards a unified framework for tracking and analysis of human motion,” in Proc. of IEEE Workshop on Detection and Recognition of Events in Video (2001) 47-54.
[27] Masoud, O. and Papanikolopoulos, N. P., “A robust real-time multi-level model-based pedestrian tracking system,” in Proc. of ITS American Seventh Annual Meeting, June 1997.
[28] Masoud, O., “Tracking and Analysis of Articulated Motion with an Application to Human Motion,” Ph.D. Thesis, Department of Computer Science and Engineering, University of Minnesota (2000).
[29] Masoud, O. and Papanikolopoulos, N., “A novel method for tracking and counting pedestrians in real-time using a single camera,” IEEE Transactions on Vehicular Technology 50(5)-(2001) 1267-1278.
[30] Maurin, B., Masoud O., and Papanikolopoulos, N. P., “Camera surveillance of crowded traffic scenes,” in Proc. of ITS American Twelfth Annual Meeting, Long Beach, Calif., April 2002.
[7] McKenna, S. J., Jabri, S., Duric Z., and Wechsler, H., “Tracking interacting people,” Proceedings of Fourth IEEE International Conference on Automatic Face and Gesture Recognition, pp. 348-353, March 2000.
[31] Myers, C., Rabiner, L., and Rosenberg, A., “Performance tradeoffs in dynamic time warping algorithms for isolated word recognition,” IEEE Transactions on ASSP 28(6) (1980) 623-635.
[32] Nayar, S. K., Nene, S. A., and Murase, H., “Real-time 100 object recognition system,” Proceedings of IEEE International Conference on Robotics and Automation, vol. 3, pp. 2321-2325, April 1996.
[33] Pavlovic, V. and Rehg, J., “Impact of dynamic model learning on classification of human motion,” in Proc. of IEEE Conference on Computer Vision and Pattern Recognition (June 2000) 788-795
[34] Polana, R. and Nelson, R., “Detecting activities,” Journal of Visual Communication and Image Representation 5(2) (1994) 172-180.
[35] Polana, R. and Nelson, R., “Detection and recognition of periodic, nonrigid motion,” International Journal of Computer Vision 23(3) (1997) 261-282.
[36] Rangarajan, K., Allen, W., and Shah, M., “Matching motion trajectories using scale space,” Pattern Recognition 26(4) (1993) 595-610.
[8] Rosales, R. and Sclaroff, S., “Improved tracking of multiple humans with trajectory prediction and occlusion modeling,” IEEE Conference on Computer Vision and Pattern Recognition, Workshop on the Interpretation of Visual Motion, 1998.
[2] Stauffer, C., and Grimson, W. E. L., “Adaptive background mixture models for real-time tracking,” Proceedings of IEEE Computer Vision and Pattern Recognition, vol. 2, pp. 2246-2252, June 1999.
[37] Swets, D. L. and Weng, J., “Using discriminant eigenfeaturesi for image retrieval,” IEEE Transactions on Pattern Recognition and Machine Intelligence 18(8) (1996) 831-836.
[38] Turk, M., and Pentland, A., “Eigenfaces for recognition,” Journal of Cognitive Neuroscience 13(1) (1991) 71-86.
[39] Wang, J., Lorette, G., and Bouthemy, P., “Analysis of human motion: a model-based approach,” in Proc. 7th Scandinavian Conference on Image Analysis, Aalborg (1991).
[40] Wren, C. R., Azarbayejani, A., Darrell, T., and Pentland, A., “Pfinder: real-time tracking of the human body,” in Proc. of the Second International Conference on Automatic Face and Gesture Recognition (October 1996) 51-56.
Wren C. R., Azarbayejani, A., Darrel, T., and Pentland, A., “Pfinder: real-time tracking of the human body,” Proceedings of the Second International Conference on Automatic Face and Gesture Recognition, pp. 51-56, October 1997.
[41] Yacoob, Y. and Black, M. J., “Parameterized modeling and recognition of activities,” Journal of Computer Vision and Image Understanding 73(2) 232-247.
[42] Yamato, J., Ohya, J., and Ishii, K., “Recognizing human action in time sequential images using Hidden Markov Model,” in Proc. of IEEE Conference on Computer Vision and Pattern Recognition (1992) 379-385.

All publications listed above are incorporated by reference herein, as though individually incorporated by reference.

### BRIEF DESCRIPTION OF THE DRAWINGS

FIG. 1 shows an example of a set of moving lights corresponding to joints of the human body with and without the human body outline.

FIG. 2 is a plot of a filter response to a step function with a set to 0.5.

FIG. 3 shows several frames from a motion sequence along with the extracted motion features, where (a) are original images and (b) are filtered images.

FIG. 4 illustrates a feature image computed in a box of dimensions 0.9 h by 1.1 h whose bottom is aligned with the base line and centered around the midline of the person.

FIG. 5 shows several frames from four actions: walk, run, skip, and march.

FIG. 6 shows several frames from four actions: line-walk, hop, side-walk, and side-skip.

FIG. 7 shows individual contribution of an eigenvector to variation in data.

FIG. 8 shows cumulative contribution of eigenvectors to variation in data.

FIG. 9 shows an example in which the first ten eigenvectors alone capture more than 60% of data variation.

FIG. 10 displays the recognition performance for different classifiers as a function of the number of eigenvectors used.

FIG. 11 shows misclassified actions.

FIG. 12 shows a confusion plot which represents the distance among test and reference actions averaged across all subjects, which gives an indication of the quality of classification.

FIG. 13 shows an example feature image and feature images normalized at different resolutions.

FIG. 14 shows classification performance for different resolutions.

FIG. 15 shows the classification results for different values of the parameter for the number of selected frames.

FIG. 16 demonstrates the relationship between the classifiers.

FIG. 17 shows a typical frame from a video of a bus stop.

FIG. 18 shows a layout of a monitoring system.

FIG. 19 shows some example snapshots of different individuals extracted from a bus stop video.

FIG. 20 shows an example of tracking output following people as they moved across the scene.

FIG. 21 shows three sets of graphical images that resulting in successful matches.

FIG. 22 shows some example matches falsely determined to be the same person by the human recognition algorithm.

FIG. 23 shows an embodiment of a system for monitoring activity at a given location.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the present invention. Other embodiments may be utilized and structural, logical, and electrical changes may be made without departing from the scope of the invention. The various embodiments are not necessarily mutually exclusive, as some embodiments can be combined with one or more other embodiments to form new embodiments. The following detailed description is, therefore, not to be taken in a limiting sense, and the scope of the embodiments of the present invention is defined only by the appended claims, along with the full scope of equivalents to which such claims are entitled.

Various embodiments and methods according to the present invention may be implemented as described below. It is particularly noted that various implementations and applications (e.g., hardware and/or software implemented) may use the techniques and/or systems or processes described herein. Further, various other apparatus and process steps described below may be included and/or may be optional according to embodiments of the present invention.

Various embodiments may include a set of algorithms that deals with the problem of activity recognition. Activity recognition is the problem of classifying the action performed by a human in a video sequence. In an embodiment, no other sensory input such as three-dimensional joint locations is used. The domain of possible actions is provided along with samples of each action. The technique may be capable of generalization to any domain with any set of actions. The actions performed may have variable durations. The same action may also have different speeds. In an embodiment, temporal alignment of actions is not required. In various embodiments, recognition may not be influenced by the actor, his/her height, shape or style in performing the actions.

The detection and tracking of human motion is an important and useful area in computer vision. There are many applications for visual tracking and analysis of human motion. In homeland security applications, monitoring incidents or movements of groups of people with the objective of noticing pre-specified actions is a task that cameras can do effectively. In user interfaces or systems that augment the human capabilities, detecting humans and their actions can help in the creation of human-centered and flexible software environments. Furthermore, activity recognition can assist the differently-abled in their interaction with the environment. In surveillance, a human operator has been traditionally used. Automating surveillance can be highly desirable in cases where using a human operator is not feasible. Automated surveillance can be used to detect intruders to a restricted area or find suspicious activities. Pedestrian traffic monitoring is another demanding application. In traffic control, tracking pedestrians at intersection can be used to both increase safety and optimize traffic timing. Safety can be increased by either providing extra crossing time for people who need extra time or by providing a warning signal to drivers indicating the presence of pedestrians in the crosswalk. Counting humans is particularly useful for retailers and shopping centers that can use the data to improve operating efficiency, evaluate performance, and charge hourly for retail spaces. In the field of entertainment, there are several interesting applications. Computer-generated movies and TV series are becoming increasingly popular. Computer games, synthetic faces, and virtual worlds are three other applications with similar demands.

Other related applications include kinesiological analysis, ergonomic designs, and biomechanical simulations. Sports is another application domain. Athletic training sometimes involves the comparison of the trajectory of certain body parts to a mathematical model of the optimum motion. Retrieval of such a trajectory is usually a tedious process which involves manually locating the joint positions in every frame. Automation of this process would be desirable. Another application would be a personalized training system, such as a virtual aerobic instructor, which provides feedback to the user performing a certain skill. Automated sports video annotation can benefit entertainment companies, newscasters, and sports teams. Video annotation, or context-based indexing of video, makes it possible to textually search the video database for events. In sports videos, the interesting events usually involve human actions that make the application a suitable human action recognition application. A typical query would be: “find segments where a player does a scissors kick in a soccer video.” Another use of video annotation is in choreography of ballet where a large vocabulary (about 800 names of steps) is used to describe it. Finally, in the domain of image compression, several compression improvements may be achieved. For example, in teleconferencing, tracking the face can allow putting more emphasis on the quality of face region and less emphasis elsewhere. Alternatively, tracking the face in 3D can provide a very short representation in terms of pose and deformation parameters. Various embodiments may used in numerous applications and are not limited to the applications described herein.

In an embodiment, methods and apparatus deal with the problem of classification of human activities from video, which is one way of performing activity monitoring. An embodiment of an approach may use motion features that are computed efficiently and subsequently projected into a lower dimensional space where matching is performed. Each action may be represented as a manifold in this lower dimensional space and matching may be performed by comparing these manifolds. In an example embodiment to demonstrate the effectiveness of such an approach, a large data set of similar actions, each performed by many different actors, may be used. Classification results may show that embodiments may handle many challenges such as variations in performers' physical attributes, color of clothing, and style of motion. An embodiment, the recovery of three-dimensional properties of a moving person or even the two-dimensional tracking of the person's limbs are not necessary steps that must precede action recognition.

In an embodiment, human action may be classified by applying principle component analysis to reduce the dimensionality of the solution space and to discard irrelevant features, among other features. Each action may be encoded as a sequence of points in eigenspace, that is, as a manifold. A metric may be used to measure similarity of two actions, which may be used to classify the action that is being evaluated. In an embodiment, computing manifolds may include calculating m eigenvectors, projecting an action in terms of k n-dimensional feature images, and forming the manifold of k m-dimensional points. In an embodiment, a metric to measure similarity of actions may include a distance metric defined as a variation of a Hausdorff metric that also satisfies the properties of metric. Classification of an action may use a distance metric that is one or more of a minimum distance (MD), a minimum average distance (MAD), or minimum distance to average (MDA). In an embodiment, classification of actions may include walk, run, skip, march, walk-on-a-line, hop, walk-sideways, and skip-sideways. A classification of actions is not limited to these actions, but may include more or less action categories. In various embodiments, prior to classifying an action, preprocessing activities may be performed including obtaining feature images, aligning frames, resizing images, performing a threshold process to remove noise and insignificant changes, normalizing feature image values, and subtracting a grand mean of eigenvectors in generation of a manifold. In various embodiments, action recognition is possible without limb tracking.

Recognition of human activity from video streams has many important surveillance applications. One such application is the monitoring suspicious activities. This application is directly related to homeland security and public safety and security at airports, transit, and public places. The approach of proceeding with a computer vision system is attractive due to the availability of high quality inexpensive cameras that makes it feasible to cover a large area. Such a system would be expected to identify suspicious activities like “putting a suitcase down and walking away.” Traditionally, operators have to evaluate a large number of video-feeds and as a result some incidents may go by unnoticed. Simple motion detectors suffer from the problem of giving too many false positives. A human, a dog, or a swaying tree will all trigger the alarm. In an embodiment, a surveillance system incorporating the teachings herein may distinguish between a human and other moving objects. Furthermore, it may distinguish a suspicious activity from a normal, regular activity.

Work in human activity recognition can be classified into three categories. The first category are those methods that use 2-D body tracking information. 2D tracking data in the form of MLDs has been used. A method has used the parameters of 2D stick figures fitted to tracked silhouettes. Another method has used 2D tracking data in the form of parameterized models of the tracked legs. The recovered parameters over the duration of the action were then compressed using principle component analysis (PCA). Matching took place in eigenspace, with a reported recognition rate of 82% using four action classes. Tracked 2D limbs have been used to learn motion dynamics using a class of learned dynamic models. Another method used tracked features on a human at the image level and propagated hypotheses probabilistically utilizing hidden Markov models (HMMs). Another method matched motion trajectories using scale space, in which speed and direction parameters were used rather than locations to achieve translation and rotation invariance. In this method, the input was a set of manually tracked points on several parts of the body performing the action. Given two speed signals, matching was performed by differencing the scale space images of the signals.

The second category methods use 3-D body tracking information. Upon successful 3-D tracking, motion recognition can make use of any or the recovered parameters such as joint coordinates and joint angles. Although there has been a tremendous amount of work in 3-D limb tracking, work done in action recognition that uses 3-D tracking information has been limited to inputs of the form of Moving Light Displays (MLDs) obtained by placing markers on various body joints which are tracked in 3-D. Techniques have included using phase-space and using dynamic time warping.

The third category uses motion features directly without attempting to track body parts. Several methods belong to this category. One such method uses PCA to represent features targeted at the problem of gait recognition, which is the identification of individuals by the way they walk. A method has also tackled the problem of gait recognition using silhouettes, area features, and applied PCA techniques. A spatio-temporal approach that can not only recognize the action but track it as well has been used, where the features used were frame-to-frame differences. In another method, HMMs have been used to distinguish different tennis strokes, where the feature vector was formed for every frame based on spatial measurements of the foreground. Recognition was then performed by selecting the HMM that was most likely to generate the given sequence of feature vectors. The main advantage of such an approach is that adding a new action can be accomplished by training a new HMM. This approach, however, was sensitive to the shape of the person performing the stroke. Use of motion features rather than spatial features may have reduced this sensitivity. Another method has used so-called motion-history images (MHIs). An MHI represents motion recency where locations of more recent motions are brighter than older motions. A single MHI is used to represent an action. A pattern classification technique using seven Hu moments of the image was then used for recognition. This approach was applied to recognizing aerobic exercises performed by two actors, one for training and one for testing. The choice of an appropriate duration parameter used in the MHI calculation is critical. Temporal segmentation was performed by trying all possible parameters. The system was able to successfully classify three different actions: sitting, arm waving, and crouching. Another method extracted motion information directly form the image sequence using normal flow, that is, the component of the flow field that is parallel to the gradient. The feature vector in this case was computed by temporally dividing the action into six divisions and finding the normal flow in each. Furthermore, each division is spatially partitioned into 4 by 4 cells. The summation of the magnitude of the normal flow at each cell was used to make up the feature vector. Recognition was done by finding the most similar vector in the training set using nearest centroid algorithm. The duration of the action was determined by calculating a periodicity measure, which helps in correcting for temporal scale but not temporal translation (or phase). To overcome this problem, the technique of this method matched the feature vector at every possible phase shift (six in this case). This method was tested using six different activities, each performed several times by the same person and one activity performed by a toy frog. The method demonstrated the discriminatory power of the motion features used.

In an embodiment, a method provides for human activity classification. In an embodiment, principle component analysis may be used to represent features in the action classification. In an embodiment, motion information directly from the video sequence may be used. Alternatively, tracking in 2-D or in 3-D may be performed that is followed by using the tracking information to do action classification. Although there has been a few successful attempts to perform limb tracking in 2D and 3D, tracking an articulated body like the human body remains a complex problem due to issues of self-occlusion and the effects of clothing on appearance. In an embodiment, a method performs action classification without having to perform limb tracking. Psychophysical evidence has demonstrated that human visual capabilities allow humans to perceive actions with ease even when presented with an extremely blurred image sequence of an action. Using motion alone to recognize actions may be favorable to reconstruction-based approaches. In an embodiment, motion may be extracted directly from an image sequence. At each frame, motion information may be represented by a feature image. Motion information may be calculated efficiently using an Infinite Impulse Response (IIR) filter. An action may be represented by several feature images rather than just one image. Actions can be complex and repetitive, making it difficult to capture motion details in one feature image. The feature image used is not limited to a small size. Higher representation resolution can provide discriminatory power when there is a similarity among actions. Dimensionality reduction using principle component analysis (PCA) may be utilized at the recognition stage. In an embodiment, action classification may be performed for actions conducted in a front-parallel fashion with respect to a camera.

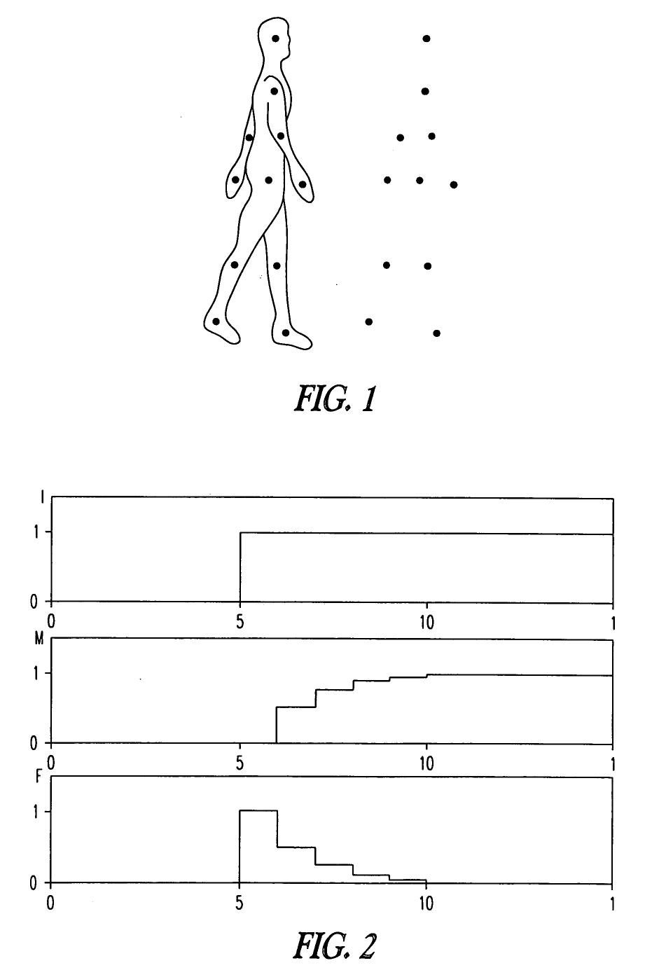

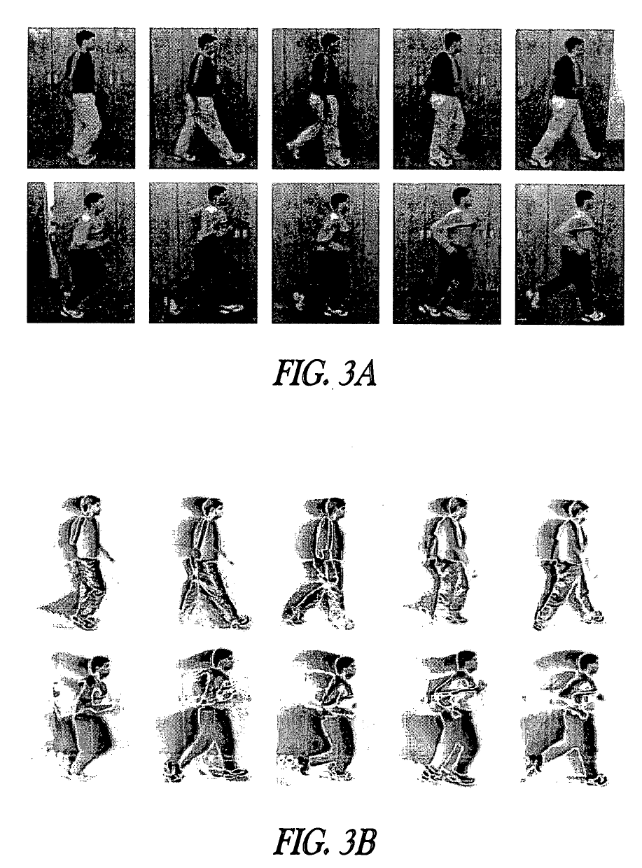

In an embodiment, an IIR filter may be used to construct the feature image. In an embodiment, particular, the response of the filter may be used as a measure of motion in the image. Motion may be represented by its recency, that is, recent motion is represented as brighter than older motion. This technique, also called recursive filtering, is straight-forward and time-efficient. It may thus be suitable for real-time applications. A weighted average at time i, Mᵢ, is computed as
Mᵢ=α×1ᵢ₋₁+(1−α)×Mᵢ₋₁, (1)
where lᵢ, is the image at time i, and α is a scalar in the range 0 to 1. The feature image at time i, Fᵢ, is computed as follows: Fᵢ=|Mᵢ−Iᵢ|. FIG. 2 is a plot of the filter response to a step function with α set to 0.5. F can be described as an exponential decay function similar to that of a capacitor discharge. The rate of decay is controlled by the parameter α. An α equal to 0 causes the weighted average, M, to remain constant (equal to the background) and therefore F will be equal to the foreground. An α equal to 1 causes M to be equal to the previous frame. In this case, F becomes equivalent to image differencing. Between these two extremes, the feature image captures temporal changes (features) in the sequence. Moving objects produce in a fading trail behind them. The speed and direction of motion are implicit in this representation. The spread of the trail indicates the speed while the gradient of the region indicates direction. FIG. 3 shows several frames from a motion sequence along with the extracted motion features using this technique. Note that it is the contrast of the gray level of the moving object which controls the magnitude of F, not the actual gray level value. The feature image values maybe normalized to be in the range [0, 1]. They may also be thresholded to remove noise and insignificant changes. A threshold of 0.05 may be appropriate. Finally, a low-pass filter may be applied to remove additional noise.

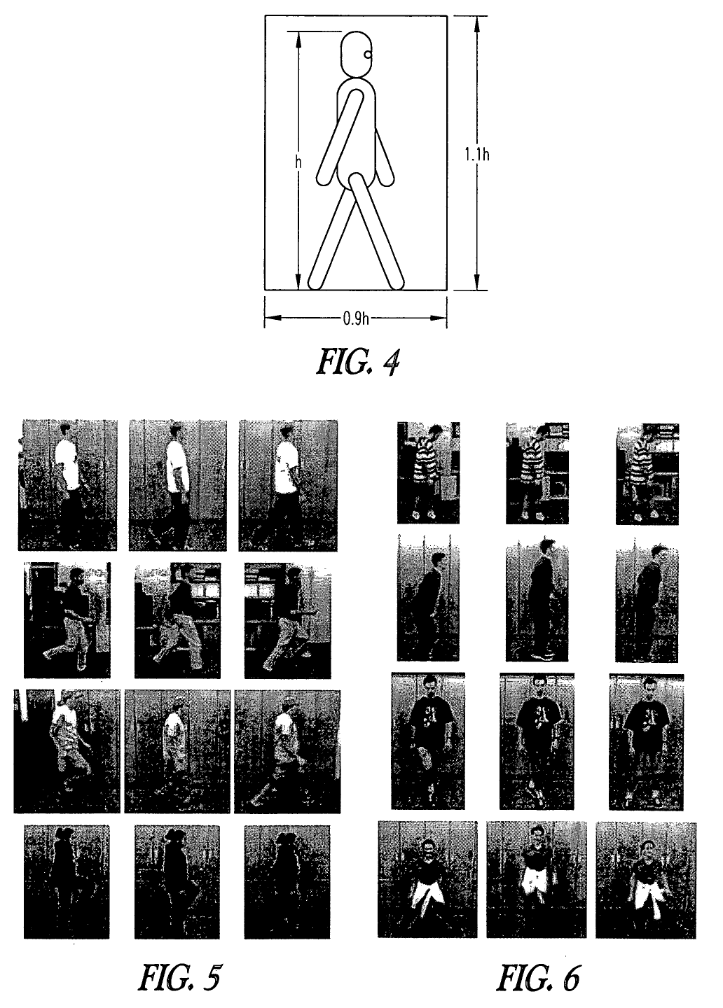

In an embodiment, with the assumption that the height, h, of the person and his/her location in the image are known, feature images are sized and located accordingly. The feature image may be computed in an box of dimensions 0.9 h by 1.1 h whose bottom is aligned with the base line and centered around the midline of the person. This is illustrated in FIG. 4. The extra height may be needed in case there are some actions that involve jumping. The width is large enough to accommodate motion of the legs and the motion trails behind them.

In an embodiment, actions may be classified into one of several categories. We use the feature image representation calculated throughout the action duration. Feature images may be compared with reference feature images of different learned actions to look for the best match. There are several issues to consider using this approach. Action duration is not necessarily fixed for the same action. Also, the method should be able to handle small speed increases or decreases. In an embodiment, even if the actions are assumed to be performed at the same speed, for example a constant speed, one cannot assume temporal alignment and therefore a frame-by-frame matching starting from the first frame should be avoided. The frame-to-frame matching process itself should be invariant to the actor's physical attributes such as height, size, color of clothing, etc. Moreover, since an action can be composed of a large number of frames, correlation-based methods for matching may not be appropriate due to their computationally intensive nature.

As actions are represented as sequences of feature images, two types of normalization may be performed on a feature image. A first type of normalization may include magnitude normalization. Because of the way feature images are computed, a person wearing clothes similar to the background will produce low magnitude features. To adjust for this, the feature image may be normalized by the 2-norm of the vector formed by concatenating all the values in all the feature images corresponding to the action. The values may then be multiplied by the square root of the number of frames to provide invariance to action length (in number of frames). A second type of normalization may include size normalization. The images are resized so that they are all of equal dimensions. Not only does this type of normalization work across different people but, it also corrects for changes in scale due to distance from the camera, for instance.

Principle component analysis has been successfully used in the field of face recognition. The use of PCA in action recognition has been limited, however. It has also been used in gait and action recognition. PCA has been used to compress features for the purpose of gait recognition, where the features consisted of regions in a self-similarity plot constructed by comparing every pair of frames in the action. In another approach to performing gait recognition, each person was represented by the centroid of the projected feature images into eigenspace. Another method used PCA on feature images computed by image differencing with the projected points then used to train HMMs. In another method, the features used were based on tracking five body parts, each tracked part provided eight temporal measurements. In total, 40 temporal curves were used to represent an action. Training data was composed of these curves for every example action. Each training sample was composed by concatenating all 40 curves. The training data were then compressed using a PCA technique. Then, an action was represented in terms of coefficients of a few basis vectors. Given a new action, recognition is done by a search process which involves calculating the distance between the coefficients for this action and the coefficients of every example action and choosing the minimum distance. This method handled temporal variation (temporal shift and temporal duration) by parameterizing this search process using an affine transformation.

In an embodiment, method and apparatus represent an action by a manifold whose points correspond to the different feature images the action goes through. Use of a manifold representation differs from an action represented by a single point in eigenspace. Use of the manifold representation moves the burden of temporal alignment and duration adjustments from searching in the measurement space to searching in eigenspace. Various embodiments provide a reduction in search complexity. Because the eigenspace has a much lower dimension than the measurement space, a more exhaustive search can be afforded. Increased robustness may also be provided in various embodiments. PCA is based on linear mapping. Action measurements are inherently nonlinear and this nonlinearity increases as these measurements are aggregated across the whole action. PCA can provide better discrimination, if the action is not considered as one entity but a sequence of entities.

In an embodiment, a training set consists of a actions each performed a certain number of times, s. For each of the as samples, normalized feature images may be computed throughout the action duration. Let the j-th sample of action i consist of Tᵢⱼ feature images: F₁^{ij}, F₂^{ij}, . . . F_{T}_{ᵢⱼ}^{ij}. A corresponding set of column vectors Sᵢⱼ=└f₁^{ij}f₂^{ij} . . . f_{T}_{ᵢⱼ}^{ij}┘ is constructed where each f is formed by stacking the columns of the corresponding feature image. To avoid bias in the training process, a fixed number L of f's may be used, since the number of feature images Tᵢⱼ for a particular sample depends on the action and how the action is performed. From every set of f's, a subset consisting of L evenly spaced (in time) vectors g₁^{ij}, g₂^{ij}, . . . , g_{L}^{ij} may be selected. L should be small enough to accommodate the shortest action. In an embodiment, to ensure that the selected feature images for the samples of one action correspond to similar postures, the samples for each action may be assumed to be temporally aligned. This restriction is removed in the testing phase. The grand mean, μ, of these vectors (g's) over all i's and j's may be computed. The grand mean is subtracted from each one of the g's and the resultant vectors are the columns of the matrix X=[x₁x₂ . . . x_{N}], where N=asL is the total number of columns. The number of rows of X is equal to the size of the feature image. The first m eigenvectors Φ=[φ₁φ₂ . . . φₘ] (corresponding to the largest m eigenvalues) may then be computed. Each sample Sᵢⱼ is first updated by subtracting μ from each column vector and then projected using these eigenvectors. Let \overline{S}ᵢⱼ=└\overline{f}₁^{ij}\overline{f}₂^{ij} . . . \overline{f}_{T}_{ᵢⱼ}^{ij}┘ be such that \overline{f}ₖ^{ij}=fₖ^{ij}−μ. The projection into eigenspace is computed as

$${Y}_{ij} = {Φ}^{T} {\overline{S}}_{ij} \\ = [ {y}_{1}^{ij} {y}_{2}^{ij} … {y}_{{T}_{ij}}^{ij} ] \qquad ( 2 )$$

Each yₖ^{ij} is an m-dimensional column feature vector which represents a point in eigenspace (the values are coefficients of the eigenvectors). Yᵢⱼ is therefore a manifold representing a sample action. The set of all the Y's from the training sequence may be referred to as the reference manifolds. Recognition may be performed by comparing the manifold of the new action to the reference manifolds.

In an embodiment, recognition may be performed by comparing the manifold of a test action in eigenspace to the reference manifolds. The manifold of the test action may be computed in the same way as described above using the computed eigenvectors at the training stage. A distance measure may be used for comparison and for classification.

The computed manifold depends on the duration and temporal shift of the action which should not have an effect on the comparison. In various embodiments, a distance measure can be used that can handle changes in duration and is invariant to temporal shifts. Given two manifolds A and B, the distance is defined as the mean minimum distance between every normalized point in A and every normalized point in B. In an embodiment, given two manifolds A=[a₁a₂ . . . aₗ] and B=[b₁b₂ . . . bₕ],

$$d ( A , B ) = \frac{1}{l} {\sum }_{i = 1 }^{l } \begin{matrix}min \\ 1 \leq j \leq h\end{matrix} ‖ \frac{{a}_{i}}{‖ {a}_{i} ‖} - \frac{{b}_{j}}{‖ {b}_{j} ‖} ‖ \qquad ( 3 )$$

may be defined as a measure of the mean minimum distance between every normalized point in A and every normalized point in B. To ensure symmetry, a distance measure that may be used includes
D(A,B)=d(A,B)+d(B,A). (4)

This distance measure is a variant of the Hausdorff metric, in which the mean of minima rather than the maximum of minima is used, which still preserves metric properties. The invariance to shifts is clear from the expression. In fact, d(,) is invariant to any permutation of points since there is no consideration for order at all. This flexibility comes at the cost of allowing actions which are not similar, but somehow have similar feature images in a different order, to be considered similar. The likelihood of this happening, however, is quite low. This approach is similar to phase space approaches where the time axis is collapsed. The temporal order in various embodiments herein is not completely lost, however. The feature image representation has an implicit locally temporal order specification. This measure also handles changes in the number of points as long as the points are more or less uniformly distributed on the manifold. The normalization of points in equation (3) is effectively an intensity normalization of feature images.

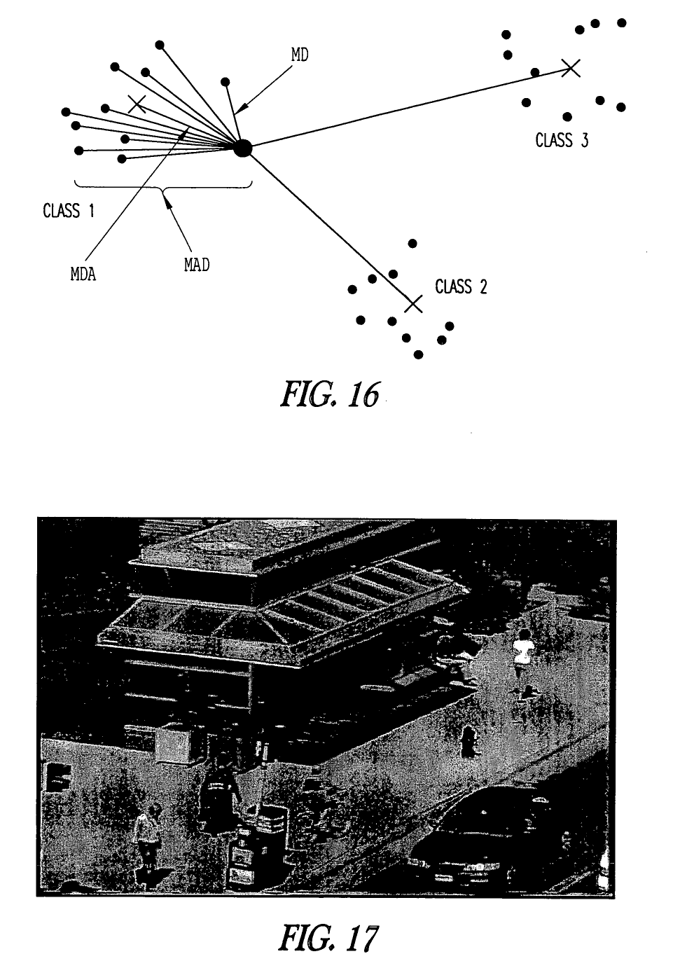

Using the distance measure equation (4), three different classifiers may be considered. A first classifier is minimum distance (MD). The test manifold is classified as belonging to the same action class the nearest manifold belongs to, over all reference manifolds. This requires finding the distance to every reference manifold. A second classifier is minimum average distance (MAD). The mean distance to reference manifolds belonging to each action class is calculated; and the shortest distance decides classification. This also involves finding the distance to every reference manifold. A third classifier is minimum distance to average (MDA), also called nearest centroid. For each action, the centroid of all reference manifolds belonging to that action is computed. This is also a manifold with a number of points equal to the average number of points in each reference manifold belonging to the action. Interpolation is not used to compute this manifold. Instead, the nearest points (temporally) on the reference manifolds are averaged to compute the corresponding point on the centroid manifold. A test manifold is classified as belonging to the action class with the nearest centroid. Testing involves calculating a number of distances equal to the number of action classes. FIG. 16 demonstrates the relationship between the classifiers.

To evaluate the recognition method, video sequences of eight actions each performed by 29 different people were recorded. Several frames from one sample of each action are shown in FIGS. 5 and 6. The actions are named as follows: Walk, Run, Skip, Line-walk, Hop, March, Side-walk, Side-skip. There are several reasons for this choice of this particular data set. Discrimination becomes more challenging when there is a high degree of similarity among actions. Many of the actions chosen are very similar in the sense that the limbs have similar motion paths. Rather than having a single person perform actions several times, many different people are used. This provides more realistic data since, in addition to the fact that people have different physical characteristics, they also perform actions differently both in form and speed. Thus, it tests the versatility of the approach. It can be seen from FIGS. 5 and 6 that subject size and clothing are different. A few samples also had more complex backgrounds. Table 1 shows the variation in action performance speed throughout the data set. The table shows that the actions were performed at significantly varying speeds (more than double the speed in the case of Hop, for instance).

TABLE 1
Variation in cycle duration for the data set.

| Action | Minimum Duration (sec.) | Maximum Duration (sec.) |
|---|---|---|
| Walk | 0.93 | 1.77 |
| Run | 0.70 | 0.93 |
| Skip | 1.10 | 1.73 |
| March | 1.13 | 1.93 |
| Line-walk | 1.47 | 2.20 |
| Hop | 0.70 | 1.67 |
| Side-walk | 1.06 | 1.80 |
| Side-Skip | 0.57 | 0.93 |

Another consideration for a more realistic data set was that the use of a treadmill is avoided. Using a treadmill not only restricts speed variation but also simplifies the problem since the background is static relative to the actor.

The video sequences were recorded using a single stationary monochrome CCD camera mounted in such a way that the actions are performed parallel to the image plane the height (in the image plane) and location of the person performing the action are assumed to be known. Recovering location may be necessary to ensure that the person is in the center of the feature images. Height is used for scaling the feature images to handle differences in subject size and distance from the camera. To attain the recovery of these parameters, the subjects were tracked as they performed the action. Background subtraction was used to isolate the subject. A simple frame-to-frame correlation was used to precisely locate the subject horizontally in every frame. A small template corresponding to the top third of the subject's body (where little shape variation is expected) was used. The height was recovered by calculating the maximum blob height across the sequence. Correlation can then be applied to find the exact displacement across frames. The computation of feature images deals with the raw image data without any knowledge of the background. The information provided by the acquisition step is the location of the person throughout the sequence and the person's height.

In experiments, the data for eight of the 29 subjects were used for training (64 video sequences). This leaves a test data set of 168 video sequences performed by the remaining 21 subjects. The training instances were used to obtain the principle components. The number of selected frames (parameter L as previously described herein) was arbitrarily set to 12. The resolution of feature images was also arbitrarily set to 25 horizontal pixels by 31 vertical pixels. Decreasing the resolution has a computational advantage but reduces the amount of detail in the captured motion.

The training samples were organized in a matrix X. The number of columns is asL=8×8×12=768. The number of rows is equal to the image size (n=25×31=775). The eigenvectors are then computed for the covariance matrix of X. Most of the 775 resulting eigenvectors do not contribute much to the variation of the data. The plot

$${λ}_{i} / ( {\sum }_{k = 1}^{n} {λ}_{k} )$$

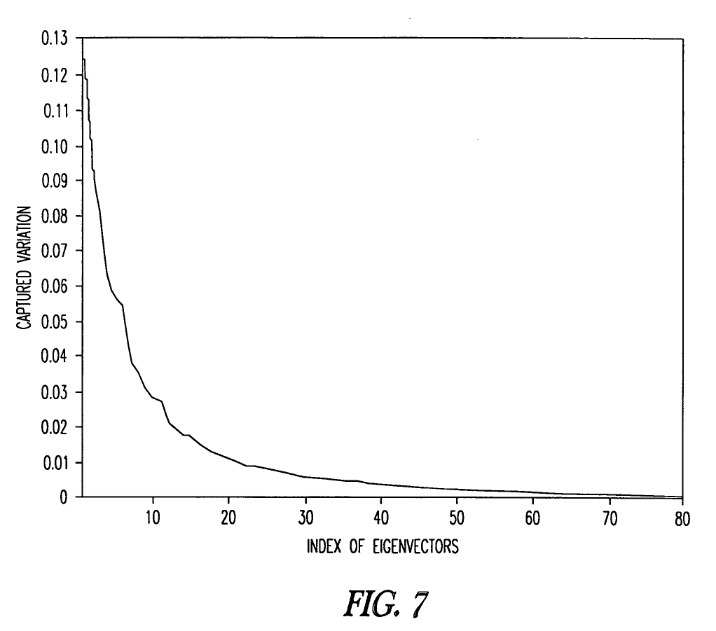

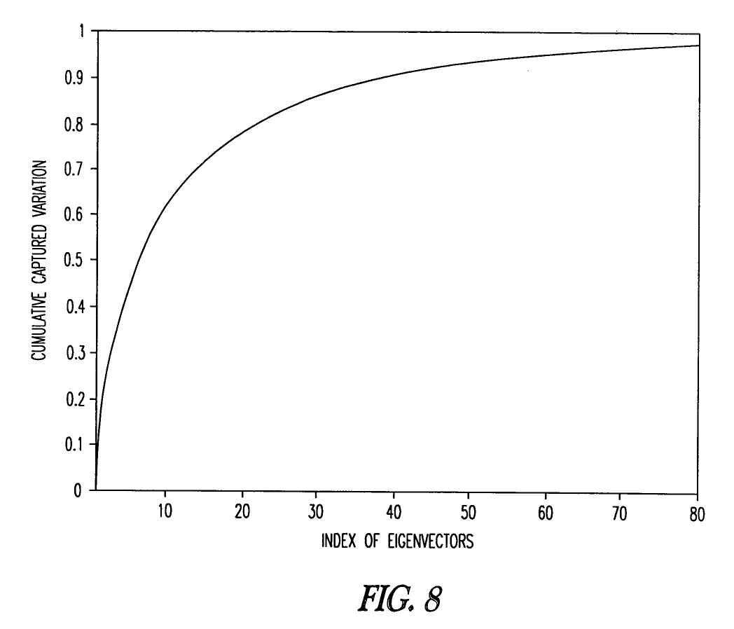

in FIG. 7 illustrates the contribution of each eigenvector. It can be seen that past the 50th eigenvector, the contribution is less than 0.5%. FIG. 8 shows the cumulative contribution

$$( {\sum }_{k = 1}^{i} {λ}_{k} ) / ( {\sum }_{k = 1}^{n} {λ}_{k} ) .$$

The curve increases rapidly during the first eigenvectors. The first ten eigenvectors alone capture more than 60% of the variation. The first 50 capture more than 90%. In FIG. 9, the first ten eigenvectors are shown. The gray region corresponds to the value of 0 while the darker and brighter regions correspond to negative and positive values, respectively. It can be seen from the figure that different eigenvectors are tuned to specific regions in the feature image.

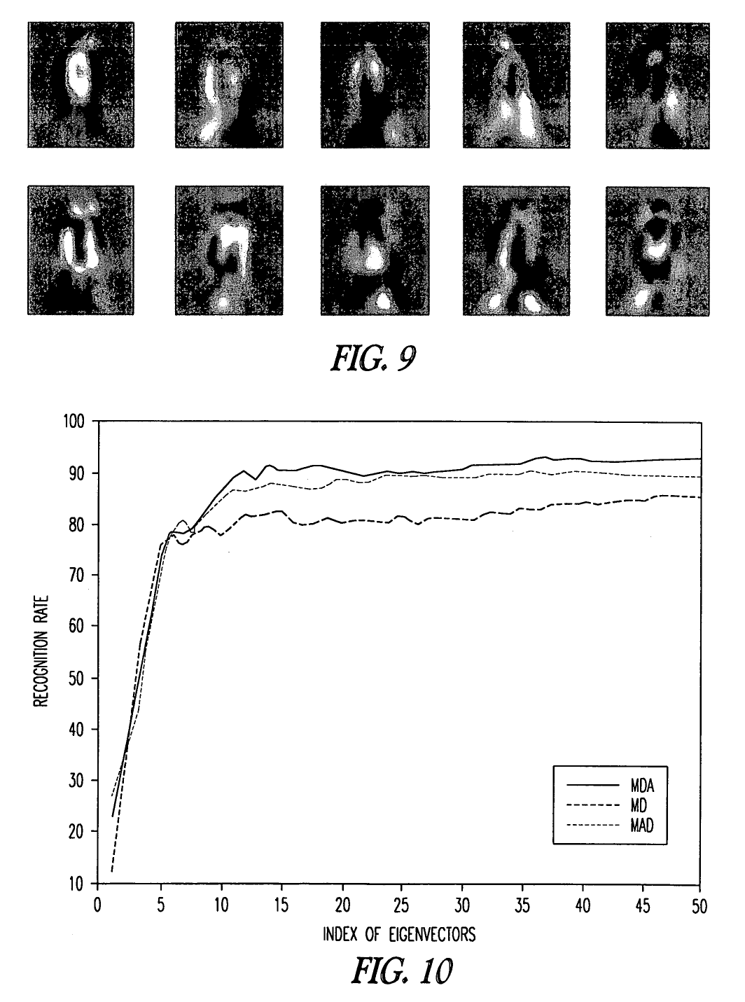

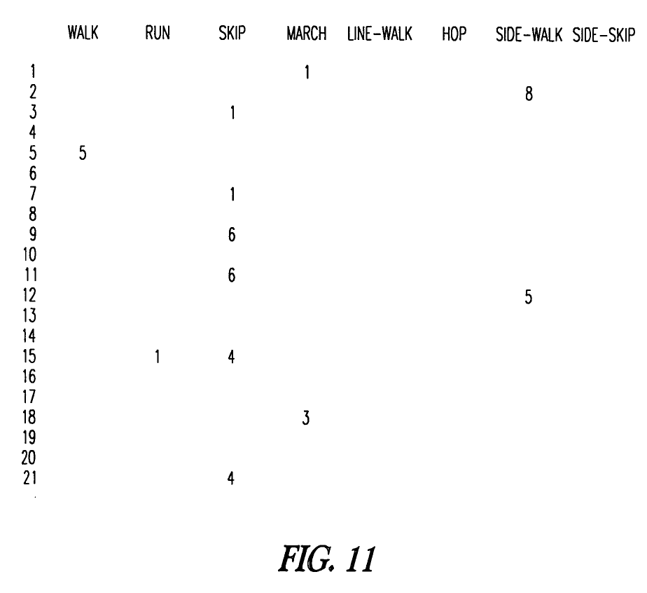

In the experiments, the choice of m (the number of eigenvectors to be used) was varied from 1 to 50. Using a small m is computationally more efficient but may result in a low recognition rate. As m increases, the recognition rate is expected to improve and approach a certain level. Recognition was performed on the 168 test sequences using all three classifiers (MD, MAD, MDA). Recognition rate was computed as the percentage of the number of samples classified correctly with respect to the total number samples. FIG. 10 displays the recognition performance for the different classifiers as a function of m. It can be seen that the recognition rate rises rapidly during the first few values of m. At m=14, the rate using MDA reaches over 91.6%. At m=50, the rate is over 92.8% for MDA. MAD performance is slightly lower while MD is about 10% below. One explanation for this behavior is that some clusters are close to each other so that a point, which may be classified correctly using MDA, can be misclassified using MD.

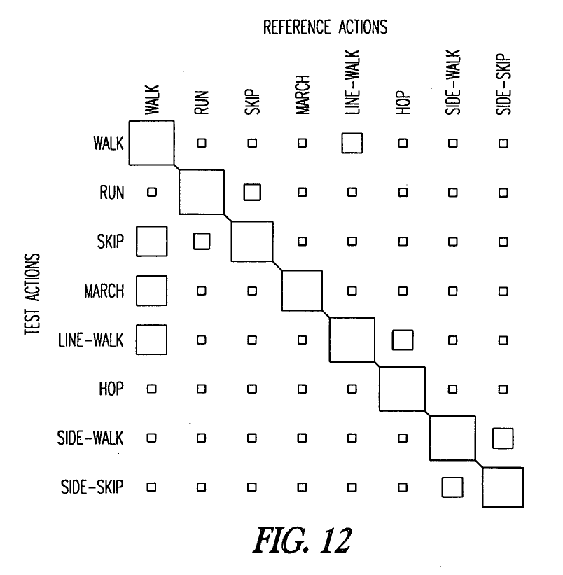

Table 2 shows the confusion matrix for m=50. Most actions had a perfect or near perfect classification except for the Skip action. Although the Skip action was classified correctly about 70% of the time, it was mistaken with Walk, March, and Hop actions numerous times. The 12 misclassified actions are shown in FIG. 11. One person (number 15) had two actions misclassified while the remaining people had at most one misclassification. When the correct action class was allowed to be within the first two choices, the number of misclassified actions became five. All these five actions (mostly Skip actions) were either executed erroneously or had a very low color contrast.

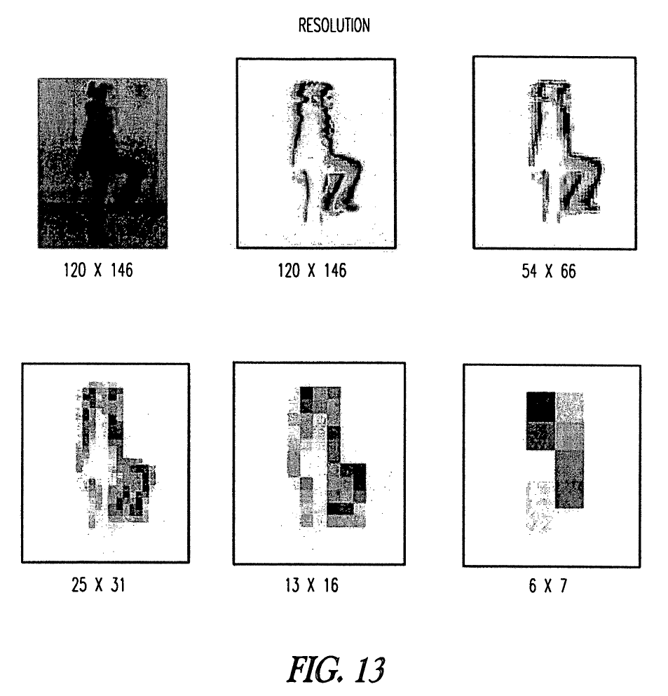

To give an indication of the quality of classification, FIG. 12 shows a confusion plot which represents the distance among test and reference actions averaged across all subjects. The larger the box size, the smaller the distance it represents. The diagonal in the figure stands out and very few other boxes come near the sizes of the boxes at the diagonal. However, it can be seen that there is mutual closeness, proximity, in matching between Walk and Skip actions (a Walk action is close to a Skip action and vise-versa). This was expected due to the high degree of similarity between these two actions.

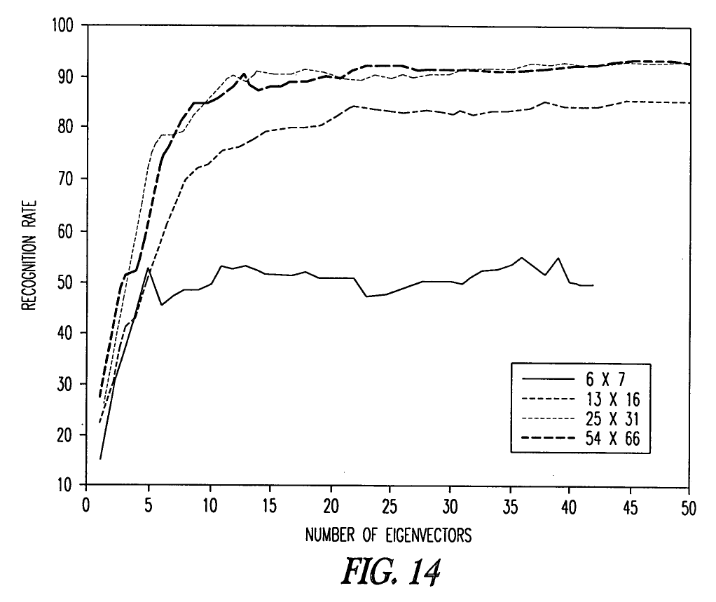

The resolution of feature images decides the amount of motion detail captured. In size normalization of feature images, a certain resolution must be chosen. FIG. 13 shows an example feature image and feature images normalized at different resolutions. The classification experiment was run with different resolutions to see if there is a resolution beyond which little or no improvement in performance is gained. Such a reduced resolution has computational benefits. It also gives an indication of the smallest “useful” resolution which can be used to decide the maximum distance from the camera at which action can take place (assuming the camera parameters are known). In FIG. 14, the classification performance is shown for different resolutions. It can be seen from the figure that increasing the resolution beyond 25×31 does not produce any gain in performance.

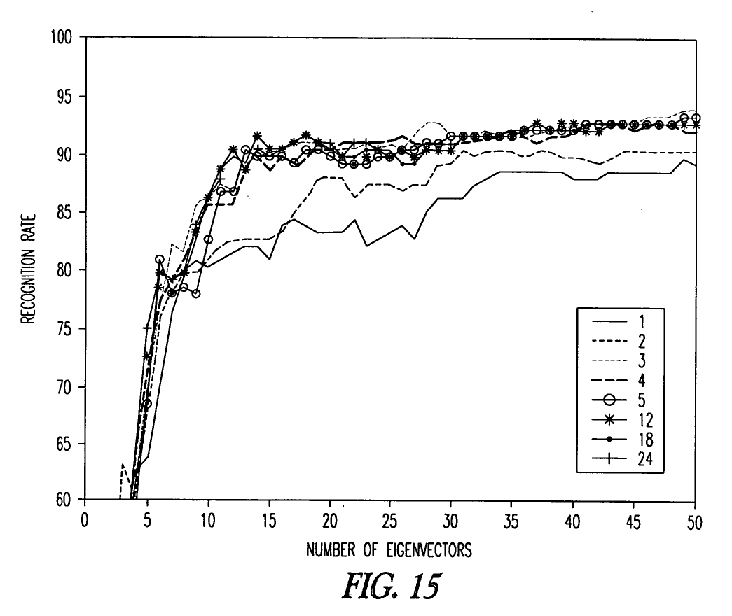

The parameter L is used in the training process to select the same number of feature images from every training action sequence. The effect of choosing different values for L on performance is examined in FIG. 15. FIG. 15 shows the classification results for the values: 1, 2, 3, 4, 6, 12, 18, and 24. Values of 3 and above seem to have identical performance. This suggests that three feature images from an action sequence capture most of the variation in the different postures.

Testing an action involves computing feature images, projecting them in eigenspace, and comparing the resulting manifold with the reference manifolds. Computing feature images requires low level image processing steps (addition and scaling of images) which can be done efficiently. Let n be the number of pixels in the scaled feature image according to the selected resolution. Using m eigenvectors, projecting a feature requires an inner product operation with each eigenvector and thus, a complexity of O(mn). If the action has l frames, the time needed to compute the manifold is O(lmn). Manifold comparison involves calculating the distance between every point on the action manifold and every point on every reference manifold. Assuming there are a action classes with s samples of each, and if the average length of the reference actions is T, there will be asTl distance calculations in the case of MD and MAD, and aTl calculations in the case of MDA. Calculating a distance between two points in an m-dimensional eigenspace is O(m). Therefore, recognizing an action using MD or MAD is O(asTlm) while in the case of MDA, it is only O(aTlm). In experiments, a=8, s=8, T=37, m=50, and n=25×31=775.

The total complexity for MDA is therefore, O(1 mn)+O(aTlm), or O(l) since the remaining variables are constant. This demonstrates the efficiency of this method and its suitability for a real-time implementation. On-line implementation is also possible where the distance measure is updated upon receiving new frames, requiring a small number of comparisons per frame. This allows incremental recognition such that certainty increases as more frames are available. The choice of the implementation approach depends on the application at hand.

Feature images may be computed in a different way than recursive filtering. Silhouettes, which are defined to be the binary mask of the foreground, may be one choice. Classification results using silhouettes were approximately 20% lower than recursive filtering. When recursive filtering was applied to silhouettes, classification rates went up by about 10%. An explanation for this behavior is that silhouettes alone do not carry any motion information, except for the spatial aspects of motion (e.g., the way a marching person should look like when his/her knee is at a right angle with his her body). Recursively filtered silhouettes on the other hand encode some motion aspect but they miss others (e.g., the motion of an arm swinging in front of one's body). Feature images do a better job than silhouettes because they encode even more motion specific information. Another approach would be to use optical flow.

TABLE 2
Confusion matrix.

| | | | | | Line- | | Side- | Side- |
|---|---|---|---|---|---|---|---|---|
| Action | Walk | Run | Skip | March | walk | Hop | walk | skip |
| Walk | 20 | 0 | 0 | 0 | 1 | 0 | 0 | 0 |
| Run | 1 | 20 | 0 | 0 | 0 | 0 | 0 | 0 |
| Skip | 2 | 0 | 15 | 2 | 0 | 2 | 0 | 0 |
| March | 1 | 0 | 1 | 19 | 0 | 0 | 0 | 0 |
| Line-walk | 0 | 0 | 0 | 0 | 21 | 0 | 0 | 0 |
| Hop | 0 | 0 | 0 | 0 | 0 | 21 | 0 | 0 |
| Side-walk | 0 | 0 | 0 | 0 | 1 | 0 | 19 | 1 |
| Side-skip | 0 | 0 | 0 | 0 | 0 | 0 | 0 | 21 |

An approach as described herein may be based on low level motion features, which can be efficiently computed using an IIR filter. Once computed, motion features at every frame, which are referred to as feature images herein, may be compressed using PCA to form points in eigenspace. An action sequence is thus mapped to a manifold in eigenspace. A distance measure may be defined to test the similarity between two manifolds. Recognition may be performed by calculating the distances to some reference manifolds representing the learned actions. Experimental results for a large data set (168 test sequences) showed recognition rates of over 92.8% have been achieved.

Methods and techniques described herein may be applied to test the effect of deviation from fronto-parallel views on performance and to investigate image-based rendering techniques to either produce novel views for training or to produce fronto-parallel views for testing. In addition to periodic actions, the methods and techniques may be used to investigate the performance with non-periodic actions. One difficulty with non-periodic actions is temporal segmentation. It is non-trivial to decide the start and end of such actions. In the case of periodic actions, temporal segmentation is possible but temporal alignment (i.e., making sure that the extracted cycle starts at a specific phase) is also non-trivial. In experiments, only temporal segmentation was assumed available (but not temporal alignment). For non-periodic actions, temporal segmentation and alignment become the same problem since there is no longer a concept of a cycle. One possible solution that will completely remove the temporal segmentation requirement for non-periodic as well as periodic actions is online recognition. Basically, at every time instant, a method may consider the past m frames where m varies from 1 to some maximum number of frames. For every m, an attempt to find a match may be made and when a good match (above some threshold) is found, the system may output that match for that time instant. Such a process is closely related to utilizing the efficiency of this approach to develop a real-time system that will classify actions as they are captured.

In embodiment, activities may be monitored at particular locations, such as monitoring human activity at the particular location for one or more purposes, including but not limited to detecting drug activity, loitering, etc. In an embodiment, the particular location may be, but is not limited to, a bus stop.

In an embodiment, a vision-based system is provided to monitor for suspicious human activities at a bus stop. The system may examine for drug dealing activity. To accomplish this goal, the system measures how long individuals loiter around the bus stop. To facilitate this, the system tracks individuals from the video feed, identify them, and keep a record of how long they spend at the bus stop. The system may be broken into three distinct portions: background subtraction, object tracking, and human recognition. The background subtraction and object tracking modules may use off-the-shelf algorithms and are shown to work well following people as they walk around a bus stop. In an embodiment, a human recognition module segments the image of an individual into three portions corresponding to the head, torso, and legs. Using the median color of each of these regions, two people can be quickly compared to see if they are the same person.

In an embodiment, a vision-based system monitors the activities of individuals at a bus stop for suspicious behavior. Autonomous vision-based systems are ideal to monitor human activities in public places such as bus depots because they are more “attentive” than a human, and free up manpower that is better assigned elsewhere. In one embodiment, focus is placed on monitoring for behavior indicative of drug dealing. According to officials at Minnesota's Metro Transit, the central behavior associated with drug dealing is presence at a bus stop for extended periods of time, indicating the person in question is loitering as opposed to taking the bus. It is important to note that drug dealers loitering around a bus stop can leave periodically and come back later, making it important to keep a record of people who have spent a lot of time at the bus stop recently and check if they have come back. Because of this, it is not safe to use motion tracking to keep track of how long a person has been in the scene to accurately time how long they have been loitering around the bus stop. In an embodiment, a procedure may be implemented that recognizes that a given person has been seen before.

There are many difficulties to overcome when implementing a vision system to work in unconstrained environments such as the outdoors. A typical frame from a video of a bus stop can be seen in FIG. 17. As this scene illustrates, the system is intended for outdoor use. Therefore, a wide range of possible lighting conditions must be accounted for. Direct sunlight, cloudy conditions, nighttime are among the possible illumination types that will be present in an outdoor environment. Another obstacle to overcome is the existence of shadows, caused either by the sun or by artificial light sources at night.

Occlusion must be accounted for. Unmovable obstacles such as street signs, newspaper machines, and fire hydrants, and the bus stop itself can all block the view of a given individual in the scene. Also of concern are occlusions of moving objects by other moving objects. A large crowd of people will occlude some individuals. It is also possible that busses and other vehicles will obscure the view of people at the bus stop, depending on the selection of camera location.

Recognition of people from a viewpoint so far away from the action is also an issue with such a system. As can be seen in the example footage in FIG. 17, the resolution of this camera used in this system is not fine enough to perform accurate biometric analysis such as face recognition. Tracking of humans across the scene can also create problems. The tracker used must be able to handle following non-rigid objects. Finally, once the individuals have been recognized as such, their actions must be classified and checked for “suspiciousness.”

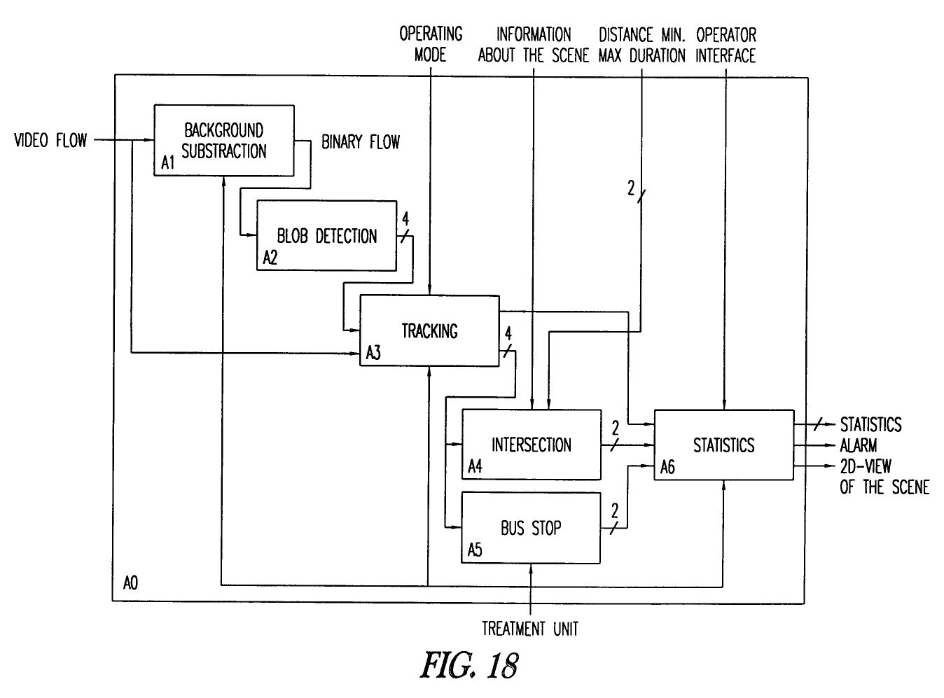

In an embodiment, a system employs techniques for foreground segmentation, tracking, and recognition. The system may use a single camera monitoring the bus stop. The system is robust in dealing with image size changes of due to perspective difference as an individual walks across the scene. Using a standard resolution of 720 by 480 pixels, the average standing person takes is between 80 and 130 pixels tall, depending on their location within the scene. The flow chart in FIG. 18 shows the layout of this system. There are three central pieces to this system: background subtraction, tracking, and human recognition.

Background modeling is an efficient way to detect moving objects in a video sequence by comparing each new frame to this background model of the scene. In order to implement background modeling, there are simple methods such as building an average image of the scene through time, although these are not very robust. One powerful tool for building such representations is statistical modeling where the intensity of each pixel in the video is modeled as a random variable in a feature space with an associated probability density function. Alternatively, nonparametric approaches could be used. These estimate the density function directly from the data without any assumptions about the underlying distribution. This avoids having to choose a model and estimating its distribution parameters. One method is the kernel density estimation technique. This method is an adaptive background modeling and background subtraction technique. It is also able to detect moving objects in outdoor environments with changes in the background like moving trees or changing illumination. The implementation of the background module may be based on this method.

In many computer vision applications, such as video surveillance, it is essential to be able to track a target in real-time. Major issues with respect to tracking algorithms are partial occlusions and moving camera. Efficiency is very important as well. In an embodiment, a tracking module is based on a robust method by Comaniciu et al. See, Comanciu, D., Ramesh, V., and Meer, P., “Kernel-based object tracking,” IEEE Transactions on Pattern Analysis and Machine Intelligence, vol. 25, no. 5, pp. 564-577, May 2003, which is incorporated by reference. This method can perform efficient tracking of non-rigid objects for which the decision process concerning the tracking is based upon the Bhattacharyya coefficient which is, in essence, a correlation score. In an embodiment, the actual method has been simplified such that the Bhattacharyya coefficient is only calculated at the end to evaluate the similarity between the target model and the chosen candidate. Thus, the method by Comaniciu et al. may be simplified into the following steps:
1. Compute the weights {wᵢ}_{{=} . . . n} according to

$${w}_{i} = {\sum }_{w = l}^{m} \sqrt{\frac{{q}_{u}}{{p}_{n} ( {y}_{o}}} δ ( b ( {x}_{i} ) - u . \qquad ( 1 )$$
2. Evaluate the new position y₁ according to

$${y}_{1} = \frac{{\sum }_{inl}^{n} {x}_{1} {w}_{1} g ( {‖ \frac{y - {x}_{1}}{h} ‖}^{2} )}{{\sum }_{inl}^{n} {w}_{1} g ( {‖ \frac{y - {x}_{1}}{h} ‖}^{2} )} \qquad ( 2 )$$

where g(x)=−k′(x). With the function k defined in Comaniciu et al. as a kernel profile, the expression of y₁ is much more simple:

$${y}_{1} = \frac{{\sum }_{inl}^{n} {x}_{1} {w}_{1}}{{\sum }_{inl}^{n} {w}_{1}} \qquad ( 3 )$$
3. If ∥y₁−y₀∥<δ, stop the algorithm. Otherwise set y₀←y₁ and go to step 1.

The target model for this method may be characterized in an embodiment of a system by the color distribution in a 16-bin histogram for each RGB color channel. The number of bins for each color channel may be fixed to 16 to keep the computation time down.

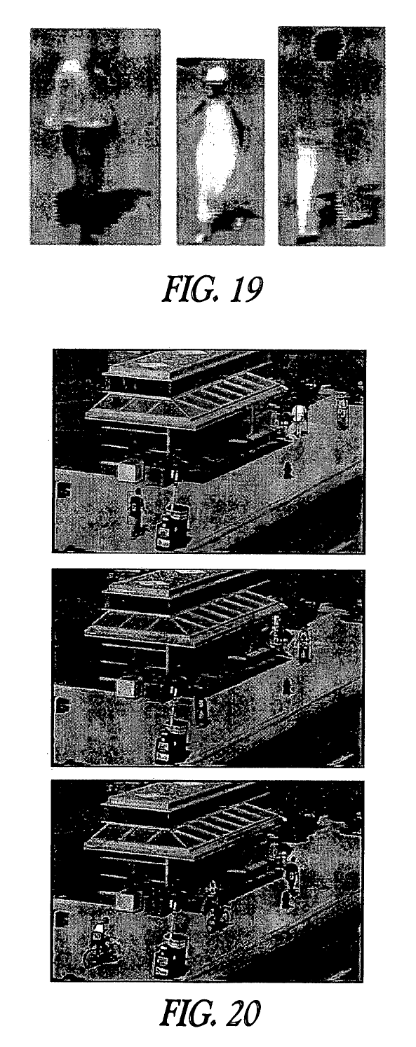

In an embodiment of a system using a single camera, individuals must be identified using a limited amount of sensory input. The field of biometrics is being researched extensively and has produced a number of methods to identify specific people. Some examples of this are fingerprint, face, and gait recognition These are all “long-term” techniques because they are supposed to remain effective for years (i.e., a person's face takes years to change dramatically, and a fingerprint will likely never change significantly). In an embodiment of a monitoring system, such as for monitoring a bus stop, “short-term” biometric techniques, where the measured attribute remains valid for hours rather than years, are sufficient. An example of a short-term biometric is clothing color. “The blonde man wearing a black shirt, green pants, and a purple jacket” is a description that would fit a single person at a bus stop. In an embodiment of a system, clothing color may be used as a short-term biometric. FIG. 19 shows some example snapshots of different individuals extracted from a bus stop video. Clothing color may be considered a very distinctive feature that should be utilized for identification.

A first step in an embodiment of a process may be to normalize the colors in the entire scene. Assuming colors in the range [0, 1], normalization may be performed by finding the mean value for each color channel, Cₖ. This mean may then be used to determine the correction factor for the channel that will cause the mean color to become 0.5. By normalizing the scene colors like this, the recognition module will hopefully be more resilient to slight changes in lighting.

$${C}_{k} {\vert}_{knl} = \frac{0.5}{mean ( {C}_{k} )} {C}_{k} \qquad ( 4 )$$

There are different ways of quantifying clothing color. Initial tests show that using the average RGB color of a person as a database key results in many incorrect identifications. An improvement to this method segments the image of an individual into three portions based upon location within the image: head, torso, and legs. This makes intuitive sense because people typically dress in a manner that can be vertically segmented into three portions. The average color is then found for each of these regions. The vertical percentage of an image occupied by each of these three segments remains fairly constant. A percentage-based method may be used because segmentation is performed exceptionally fast. A method was attempted previously that performed the segmentation by finding the best position of two “cuts” in the image such that the total standard deviation of the pixel colors in each segment is minimized. While making intuitive sense, in practice, this method did not correctly segment the images in most cases.

Thus, each person in the database has three median colors to compare. To recognize if two images belong to the same individual, a similarity measure is computed. The measure (d) compares the median color of the three segments as follows:

$$d = \frac{\vert {c1}_{h} - {c2}_{h} \vert + \vert {c1}_{t} - {c2}_{t} \vert + \vert {c1}_{l} - {c2}_{l} \vert}{3} \qquad ( 5 )$$

where ci, is the median color of portion x {h:head, t:torso, l:leg} of the individual i. The measure d is normalized to exist in the range [0:1]. The difference between two colors is the Euclidian distance in the RGB color space. Drawbacks to this method include recognizing individuals who dress alike, such as a marching band as well as people who cross into areas of deep shadows.

In an example embodiment, a system includes a computer equipped with a Pentium 4 2.66 GHz processor and 1 GB main memory running Microsoft Windows 2000. The tracking module works very well following people as they moved across the scene. FIG. 20 shows example tracking output. It can be seen that it is successfully tracking all of the moving people in the scene. The occlusion caused by the newspaper stand and street sign in the foreground in FIG. 20 is handled acceptably.

The tracking algorithm can be used with the system in real time. Table 3 shows results tracking a number of targets at different resolutions and the frames per second that may be used. As can be seen, tracking can be performed in real-time with color video with 320×240 resolution.

TABLE 3
Tracking Module Computation Speed

| | Video | Number of | Computation |
|---|---|---|---|
| Video Color | Resolution | Targets | Speed (fps) |
| Color | 720 × 480 | 1 | 25 |
| | | 2 | 21.3 |
| | | 5 | 12.8 |
| | | 10 | 10.6 |
| Color | 320 × 240 | 1 | >70 |
| | | 5 | 62.5 |
| | | 10 | 32 |
| Grayscale | 320 × 240 | 5 | >70 |
| | | 10 | 66.6 |
| | | 20 | 62.5 |
| | | 50 | 32.2 |

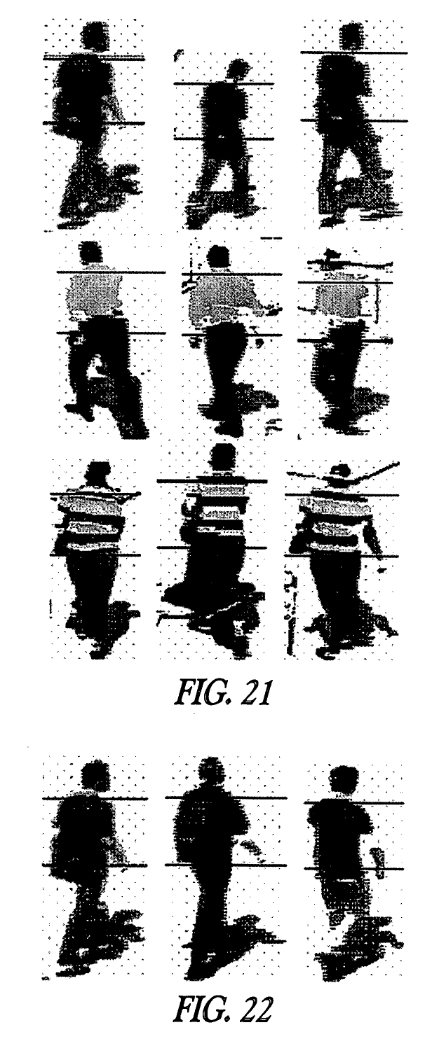

The human recognition algorithm was tested with a test set of 21 people with between three and nine images for each person (106 images total). By checking all possible combinations in this test set, the algorithm was found to have an accuracy of 82%. FIG. 21 shows three sets of graphical images that resulted in successful matches. Also shown is the placement of the two segmentation cuts. FIG. 22 shows some example matches falsely determined to be the same person by the human recognition algorithm. This figure clearly illustrates the algorithm's drawbacks when multiple people dress in a similar fashion.

In an embodiment, a vision-based system monitors for suspicious human activities at a bus stop. The system may examine for abnormal activity that may be characterized by individuals loitering around the bus stop for a very long time without the intention of using the bus. To accomplish this goal, the system measures how long individuals loiter around the bus stop. To facilitate this, the system tracks individuals from the video feed, identify them, and keep a record of how long they spend at the bus stop. The system is broken into three distinct potions: background subtraction, object tracking, and human recognition. The background subtraction and object tracking modules may use off-the-shelf algorithms and are shown to work well following people as they work around a bus stop. The human recognition module segments the image of an individual into three portions corresponding to the head, torso, and legs. Using the median color of each of these regions, two people can be quickly compared to see if they are the same person. Embodiments of methods, apparatus, and systems are not limited to tracking humans, but may be applied to tracking other target objects. Further, segmenting target objects, such as humans, is not limited to segmenting the target into three portions, but may segment the target in any number of portions. In other embodiments, biometric attributes other than color may be used.

To recognize people by color, who have previously been in the scene, image segmentation of body portions may used. A method that uses optical flow to determine which part of an image corresponds to head, torso, and legs could help improve identification of individuals. Other methods to recognize people may be utilized. One possible method may use a texture-based approach to distinguish individuals. Another possibility is to use the number of steps required to morph the image of one person into another as a heuristic to tell whether they are the same person or not. In an embodiment, a system may recognize certain behaviors. Behaviors for which the system may examine an individual include suspicious activities such as leaving a package or stretching for extended periods of time without ever jogging. Other actions to recognize are more benign, for instance, fainting or other medical emergencies.

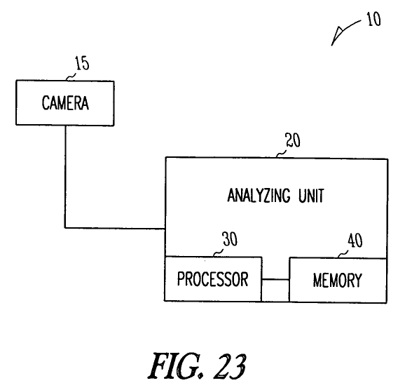

FIG. 23 shows an embodiment of a system 10 for monitoring activity at a given location. System 10 includes a camera 15 and an analyzing unit 20 to receive an image from the camera. Analyzing unit 20 may be used to determine if the image correlates to one or more of images. Analyzing unit 20 may be adapted to segment an image of a target into a plurality of portions, determine a value of a biometric attribute for each of the segmented portions, and compare each value of the biometric attribute with other values of the biometric attribute of corresponding portions of other images. In an embodiment, analyzing unit 20 may include a processor 30 coupled to a memory 40 to control the tasks of analyzing. In an embodiment, analyzing unit 20 may be realized as a processor working with memory. Various embodiments or combination of embodiments for apparatus, systems, and methods for a monitoring activity as discussed herein may be realized in hardware implementations, software implementations, and combinations of hardware and software implementations. These implementations may include a computer-readable medium having computer-executable instructions for performing an embodiment of a monitoring activity, such as monitoring activity of a target by segmenting the target from a video image and tracking a value of biometric attributes of each portion relative to other images. In an embodiment, implementations may include a computer-readable medium having computer-executable instructions for performing an embodiment of a monitoring activity, such as monitoring activity of a target by classifying actions of a target. In an embodiment, implementations may include a computer-readable medium having computer-executable instructions for performing an embodiment of a monitoring activity that includes segmenting a target from a video image and tracking a value of biometric attributes of each portion relative to other images and classifying actions of the target. In an embodiment, a computer-readable medium includes memory working in conjunction with processor. The computer-readable medium is not limited to any one type of medium. The computer-readable medium used will depend on the application using an embodiment.

In an embodiment, the image of the target is an image of an individual. The biometric attribute associated with the target may be a short-term biometric attribute, such as a median color. Biometric attributes associated with various images of numerous targets may be stored in a memory of the system 10. System 10 may include an alarm responsive to analyzing unit 20 to alert appropriate individuals regarding suspicious activities or excessive time spent at the given location by the target.

The analyzing unit 20 may be configured to monitor the actions of an identified target. In an embodiment, analyzing unit 20 may be adapted to construct feature images from a number of received action images of an action of a target, where each action image may be associated with a different time, to project the feature images in terms of eigenvectors, where the eigenvectors may be formed from a training process, to generate a manifold of the action from the feature images projected in terms of eigenvectors, and to compare the manifold with reference manifolds to classify the action as one of a set of action categories. The projection of the features images may be performed in terms of eigenvectors using principle component analysis. Analyzing unit 20 may be adapted to perform a training process to determine the eigenvectors from actions in the set of action categories.

Although specific embodiments have been illustrated and described herein, it will be appreciated by those of ordinary skill in the art that any arrangement which is calculated to achieve the same purpose may be substituted for the specific embodiment shown. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the invention includes any other applications in which the above structures and fabrication methods are used.

What is claimed is:

1. A method comprising:
segmenting an image of a target into a plurality of portions;
determining a value of a biometric attribute for each of the segmented portions; and
comparing each value of the biometric attribute with other values of the biometric attribute of corresponding portions of other images to determine if the image correlates to one or more of the other images.

2. The method of claim 1, wherein segmenting an image of a target includes segmenting an image of an individual.

3. The method of claim 2, wherein segmenting an image of an individual includes segmenting the image into three portions.

4. The method of claim 3, wherein segmenting the image into three portions includes segmenting the image corresponding to a head, a torso, and legs.

5. The method of claim 1, wherein determining a value of a biometric attribute includes determining a value of a short-term biometric attribute.

6. The method of claim 5, wherein determining a value of a short-term biometric attribute includes determining a color.

7. The method of claim 5, wherein determining a value of a short-term biometric attribute includes determining a median color.

8. The method of claim 7, wherein the method includes identifying an individual comparing each median color of the segmented portions with other median colors of corresponding portions of other images and determining a length of time that the identified individual has been at a location.

9. The method of claim 7, wherein the method includes obtaining images of targets at a location;
subtracting background from the images; and
tracking one or more of the targets at the location for which the comparison of median colors is performed to identify the tracked targets.

10. The method of claim 9, obtaining images of targets includes obtaining images of individuals.

11. The method of claim 9, obtaining images of targets includes obtaining images from a single camera.

12. The method of claim 1, wherein the method further includes
receiving a number of action images of an action of the target, each action image being associated with a different time;
constructing feature images from the number of action images of the action;
projecting the feature images in terms of eigenvectors, the eigenvectors formed from a training process;
generating a manifold of the action from the feature images projected in terms of eigenvectors;
comparing the manifold with reference manifolds to classify the action as one of a set of action categories.

13. The method of claim 12, wherein projecting the feature images in terms of eigenvectors includes projecting the feature images in terms of eigenvectors using principle component analysis.

14. The method of claim 12, wherein the method includes performing a training process to determine the eigenvectors from actions in the set of action categories.

15. The method of claim 14, wherein the method includes storing the eigenvectors.

16. The method of claim 12, wherein constructing feature images includes using an infinite impulse response (IIR) filter.

17. The method of claim 16, wherein using an infinite impulse response (IIR) filter includes using responses from the filter as a measure of motion of the action images.

18. The method of claim 12, wherein receiving a number of action images of an action includes receiving each action image of the action performed parallel to a plane of each image.

19. The method of claim 12, wherein comparing the manifold of feature images with reference manifolds includes using a distance measure to define a classifier of the action.

20. The method of claim 12, wherein the method includes providing information to a monitoring control system identifying the action as one of a set of action categories based on comparing the manifold of feature images with reference manifolds.

21. A computer-readable medium having computer-executable instructions for performing a method comprising:
segmenting an image of a target into a plurality of portions;
determining a value of a biometric attribute for each of the segmented portions; and
comparing each value of the biometric attribute with other values of the biometric attribute of corresponding portions of other images to determine if the image correlates to one or more of the other images.

22. The computer-readable medium of claim 21, wherein segmenting an image of a target includes segmenting an image of an individual.

23. The computer-readable medium of claim 21, wherein segmenting the image into three portions includes segmenting the image corresponding to a head, a torso, and legs.

24. The computer-readable medium of claim 21, wherein determining a value of biometric attribute includes determining a value of a short-term biometric attribute.

25. The computer-readable medium of claim 21, wherein determining a value of a short-term biometric attribute includes determining a median color.

26. The computer-readable medium of claim 25, wherein the computer-readable medium includes instructions to identify an individual by comparing each median color of the segmented portions with other median colors of corresponding portions of other images and determining a length of time that the identified individual has been at a location.

27. The computer-readable medium of claim 25, wherein the computer-readable medium includes instructions to:
obtain images of targets at a location;
subtract background from the images; and
track one or more of the targets at the location for which the comparison of median colors is performed to identify the tracked targets.

28. The computer-readable medium of claim 27, wherein to obtain images of targets includes obtaining images of individuals.

29. The computer-readable medium of claim 27, to obtain images of targets includes obtaining images from a single camera.

30. The computer-readable medium of claim 21, wherein the computer-readable medium includes instructions to:
construct feature images from a number of received action images of an action of the target, each action image being associated with a different time the number of action images of the action;
project the feature images in terms of eigenvectors, the eigenvectors formed from a training process;
generate a manifold of the action from the feature images projected in terms of eigenvectors;
compare the manifold with reference manifolds to classify the action as one of a set of action categories.

31. The computer-readable medium of claim 30, wherein to project the feature images in terms of eigenvectors includes projecting the feature images in terms of eigenvectors using principle component analysis.

32. The computer-readable medium of claim 30, wherein the computer-readable medium includes instructions to perform a training process to determine the eigenvectors from actions in the set of action categories.

33. An apparatus comprising:
a video input to receive an image of a target;
an analyzing unit to determine if the image correlates to one or more of other images, the analyzing unit adapted to:
segment the image into a plurality of portions;
determine a value of a biometric attribute for each of the segmented portions; and
compare each value of the biometric attribute with other values of the biometric attribute of corresponding portions of other images.

34. The apparatus of claim 33, wherein the image includes an image of an individual.

35. The apparatus of claim 33, wherein the biometric attribute includes a short-term biometric attribute.

36. The apparatus of claim 35, wherein the short-term biometric attribute includes a color.

37. The apparatus of claim 35, wherein the short-term biometric attribute includes a median color.

38. The apparatus of claim 33, wherein the video input is adapted to receive the image from a camera.

39. A system comprising:
a camera; and
an analyzing unit to receive an image from the camera, the analyzing unit to determine if the image correlates to one or more of other images, the analyzing unit adapted to:
segment an image of a target into a plurality of portions;
determine a value of a biometric attribute for each of the segmented portions; and
compare each value of the biometric attribute with other values of the biometric attribute of corresponding portions of other images.

40. The system of claim 39, wherein the analyzing unit includes a processor coupled to a memory.

41. The system of claim 39, wherein the image includes an image of an individual.

42. The system of claim 39, wherein the biometric attribute includes a short-term biometric attribute.

43. The system of claim 42, wherein the short-term biometric attribute includes a median color.

44. The system of claim 39, wherein the system includes an alarm responsive to the analyzing unit.

45. The system of claim 39, wherein the system includes a memory to store the other values of the biometric attribute.

46. The system of claim 39, wherein the analyzing unit is adapted to:
construct feature images from a number of received action images of an action of the target, each action image being associated with a different time;
project the feature images in terms of eigenvectors, the eigenvectors formed from a training process;
generate a manifold of the action from the feature images projected in terms of eigenvectors;
compare the manifold with reference manifolds to classify the action as one of a set of action categories.

47. The system of claim 45, wherein to project the feature images in terms of eigenvectors includes projecting the feature images in terms of eigenvectors using principle component analysis.

48. The system of claim 46, wherein the analyzing unit is adapted to perform a training process to determine the eigenvectors from actions in the set of action categories.
